(19) United States
(12) Patent Application Publication
(10) Pub. No.: US 2019/0132621 A1
(43) Pub. Date: May 2, 2019

(54) METHODS AND SYSTEMS FOR INDEPENDENT, PERSONALIZED, VIDEO-SYNCHRONIZED, CINEMA-AUDIO DELIVERY AND TRACKING

(71) Applicant: MUVIX MEDIA NETWORKS LTD, Petah Tikva (IL)

(72) Inventors: Ilan Shiber, Ganei Tikva (IL); Alon Cohen, Zikhron Ya'akov (IL)

(21) Appl. No.: 16/093,973

(22) PCT Filed: Apr. 20, 2016
(86) PCT No.: PCT/IL2016/050419

§ 371 Date: Oct. 16, 2018

(51) Int. Cl. H04N 21/239; H04N 21/214; H04N 21/258

(52) U.S. Cl. CPC H04N 21/2396; H04N 21/25875; H04N 21/2143

(57) ABSTRACT

The present invention discloses methods and systems for independent, personalized, video-synchronized, cinema-audio delivery and tracking. Methods include the steps of: upon receiving at least one film each having a video source file and at least one audio source file including at least one initial, digital alignment-marker for the video source file and at least one audio source file based on marker information, independently identifying at least one audio-subscriber device; upon receiving at least one request from at least one audio-subscriber device for audio-channel delivery, verifying at least one delivery authorization for at least one audio-subscriber device based on fulfillment criteria; and upon receiving at least one delivery-authorization confirmation, independently delivering and tracking at least one video-synchronized audio channel to each at least one audio-subscriber device. Alternatively, upon receiving a common A/V source file, discretizing the common A/V source file into separate video source file and at least one audio source.

### FIELD AND BACKGROUND OF THE INVENTION

The present invention relates to methods and systems for independent, personalized, video-synchronized, cinema-audio delivery and tracking.

As modern, electronic, personal devices (e.g., smartphones and tablet computers) become ubiquitous, the “bring your own device” (BYOD) ethos has become increasingly pervasive as consumers are more inclined to opt for customized applications and services for personal as well as business use. As such devices gain more capabilities (e.g., processing power), the range of use cases for “sharing” computational tasks has broadened in the distributed environment, which can span the customer-supplier divide.

The film industry (including film distribution and screening operators, movie theaters, outdoor-screening event planners, “drive-in” theaters, and other public-screening organizers) has evolved to continually offer technological advancements (e.g., 3D motion video, 4D seat-effect simulation, 5D sensory experiences such as smoke and mist, Sensurround, Dolby, and THX). However, allowing the consumer to make on-demand, “in-event” theater choices has generally not been available nor considered.

Typically, the gamut of options available to a moviegoer are predetermined. While cinema multiplexes offer a variety of movie selections (e.g., film choice, movie times, seating, 3D versions, subtitled screenings, and enhanced aural environments), the consumer is restricted to the offerings available for a particular showing, which is usually predicated on having maximal appeal and value to a majority of would-be viewers. “Consumer customization” in such a service industry is not a possibility, with the only alternate choice available to the consumer being opting out of the movie selection or the movie event altogether.

Returning to the BYOD model, such concepts nave not been integrated into the cinema experience primarily due to a lack of technological capabilities to handle the stringent demand of synchronous video and audio playback such that no lip-sync errors are introduced, resulting in a poor and unacceptable experience for the paying moviegoer. Furthermore, the ability to discretely manage and track delivery of various audio channels to individual moviegoers during a film screening is exacerbated by the fact that state-of-the-art methods rely on centralized speaker systems, in addition to the synchronization challenge just mentioned.

The traditional central speaker system is inherently principled on the assumption that no personal audio devices are utilized. Another principle is that the audio is available for everyone attending the film screening, without personalization (e.g., alternate language editions). Since the audio “delivery” is a “mass/bulk” delivery by nature of the simple fact that the sound fills air of the theater, it cannot be personalized.

Wireless infrared- or RF-(i.e., AM/FM) based headsets, typically implemented for outdoor/drive-in screenings utilize such transmission, relying on the audio being received by transmission-paired headphones (usually offered by the screening operator), the viewers' vehicular sound systems, or the viewers' RF-supported smartphones. However, such audio delivery is dealing with a single, predetermined, audio channel as above, and thus again is a mass/bulk delivery, albeit employing alternate means. The same shortcomings equally apply to Assistive-Listening Device (ALD) systems, which are sometimes available in movie theaters, broadcasting the audio (via either infrared or FM) for the benefit of the hearing impaired.

The use of wired headphones is impractical for cinematic use because of the inherent aspects of: reliance on a rigid, non-scalable solution, substantial setup costs, and a viewing experience resulting in restricted physical viewer-mobility. The same shortcomings equally apply to central In-Flight Entertainment (IFE) systems and TV-connected wireless headphones.

All of the prior art methods described above fall short of providing a personalized, cinema-audio experience, besides the fact that such methods provide no ability to manage, track, and thus monetize such audio-channel access as a form of advanced digital rights management (DRM).

It would be desirable to have methods and systems for independent, personalized, video-synchronized, cinema-audio delivery and tracking. Such methods and devices would, inter alia, overcome the various limitations mentioned above.

### SUMMARY

It is the purpose of the present invention to provide methods and systems for independent, personalized, video-synchronized, cinema-audio delivery and tracking.

It is noted that the term “exemplary” is used herein to refer to examples of embodiments and/or implementations, and is not meant to necessarily convey a more-desirable use-case. Similarly, the terms “alternative” and “alternatively” are used herein to refer to an example out of an assortment of contemplated embodiments and/or implementations, and is not meant to necessarily convey a more-desirable use-case. Therefore, it is understood from the above that “exemplary” and “alternative” may be applied herein to multiple embodiments and/or implementations. Various combinations of such alternative and/or exemplary embodiments are also contemplated herein.

For purposes of clarity, several terms are defined herein. The term “synchronized” is used herein to refer to a state in which audio and video streams are aligned in time to within a detectable human limit for perceiving synch errors (i.e., about 20 ms). The term “high-latency conditions” is used herein to refer to any system process in operation exceeding at least in part a transmission time of about 30 ms.

The term “low-enough latency” is used herein to refer to a communication medium that doesn't introduce delays deemed significant which are longer than the detectable human limit for perceiving synch errors during normal operation. The term “high-enough bandwidth” is used herein to refer to a communication medium that can deliver A/V streams to a component on time without causing delays longer than the detectable human limit for perceiving synch errors during normal operation.

The term “cinema audio” is used herein to refer to any audio portion intended to accompany a video screening for more than one viewer in a synchronized manner, including indoor screenings, outdoor screenings, public screenings, and private screenings.

Embodiments of the present invention enable independent, personalized, video-synchronized, cinema-audio delivery to cinema viewers for an enhanced experience, while at the same time improving the efficiency and profitability of film-industry players (including cinema operators, film producers, and movie “localizers” in foreign markets).

For instance, such independent, personalized, video-synchronized cinema-audio delivery arises if one is interested in displaying a movie or other video content on at least one video display (e.g., TV or projection screen) while simultaneously and synchronously playing the soundtrack on one or more smartphones. The motivation for splitting the A/V outputs into discrete video and audio channels might be in order to let each viewer listen to the movie's soundtrack via their own device and headphones or other peripheral devices connected to their individual smartphones, enabling each viewer to personalize their audio portion according to personal preferences.

Such audio personalization includes transforming the audio (e.g., changing the volume and applying advanced signal processing), as well as replacing an original audio portion with a different audio version or edition (e.g., a foreign language dubbing). Such audio personalization is considered “independent” in the sense that each viewer can make their own independent choice of personalization. Similarly, viewers who elect to not request an audio portion are left to experience a “silent viewing” surrounded by fellow audience members who are “audio-personalized” viewers—that is, embodiments of the present invention eliminate the “freeloader” problem for non-paying viewers. Such non-paying viewers are inconvenienced by the lack of the audio experience which would otherwise not occur in a centralized-audio scenario.

Whatever the reason for such a concerted “display/play” mode might be, in all cases it is crucial to be able to fully synchronize the A/V outputs, such that no lip-sync errors are introduced to any of the standalone A/V systems. Embodiments of the present invention employ a distributed, cross-synchronization using an A/V “orchestrator” to which multiple standalone A/V systems (i.e., multiple A/V players in the A/V “orchestra”) can join and take part in an orchestrated display/play performance. The standalone A/V systems interact with the A/V orchestrator via a “client” component which serves like the “score” of the A/V performance, leading the concerted play-display synchronization. Such A/V orchestrator systems become highly beneficial, and in many cases crucial, in multi-component implementations. Such an A/V orchestra is not only synchronized, but also “concerted” by also allowing for delays (e.g., due to network lags) without impacting playback.

The details of such an A/V orchestrator are the subject of a separate patent application entitled, “Methods and Devices for Distributed Audio/Video Synchronization and Playback Using an A/V Orchestrator” (U.S. Provisional Patent Application No. 62/099,167, Israel Patent Application No. 240927, U.S. patent application Ser. No. 14/980,917, and EP Application No. 15202792.6, which are hereby incorporated by reference in their entirety) filed by the Applicant of the present invention.

A typical A/V system is configured as a linked architecture of A/V system components, operationally coupled together through a low-latency connectivity framework, which is required in order to ensure high A/V quality, as well as to meet the stringent A/V synchronization criteria. At the top of the hierarchy is a centralized A/V player, and at the bottom are the A/V output devices (e.g., TV monitors, VGA monitors, video projectors, speakers, wired headphones, and Bluetooth headphones). The A/V player (coupled with a set of system tools) is responsible for synchronizing the A/V streams. A queue of synched A/V segments are delivered by the A/V player downstream to the A/V control units, which in turn renders and transmits the segments to the A/V output devices for play-display synchronization. The process of sending the synchronized A/V streams, and the play-display process has to occur within very strict timing constraints, otherwise synchronization won't be retained.

Such an A/V orchestra may operate over any flexible (i.e., having high-latency and/or low-bandwidth) networking platform available, wired or wireless, including high-level computer-based networks (e.g., Wi-Fi, Ethernet, cellular 3G/4G, and the Internet), which usually cannot necessarily guarantee low-enough latency and high-enough bandwidth. Once such an A/V orchestra is formed, any standalone A/V system is able to join and synchronously play an audio track associated with video content that is simultaneously displayed on a separate standalone (usually central) A/V system. Conversely, any standalone A/V system is able to join and synchronously display video content associated with an audio track that is simultaneously played on a separate standalone (usually central) A/V system. Such an A/V orchestra enables all such standalone systems to function in a concerted manner, akin to an orchestra, keeping all such A/V streams synchronized—ensuring no synchronization errors are introduced on any A/V system.

As an exemplary implementation, a smartphone (i.e., a standalone A/V system) can play the soundtrack of a cinematic movie displayed on a central video monitor (i.e., a separate standalone A/V system), while ensuring A/V synchronization. Such synchronization occurs just as if the smartphone's audio system was attached as a peripheral device to the video monitor, but without the rigid and strict constraints mat would otherwise be imposed on the connectivity between the two components.

The benefits of such an A/V orchestrator result in part from the connectivity options available for such play-display synchronization. Alternative approaches would require wired connections or non-scalable wireless solutions such as AM/FM transmission or Bluetooth. AM/FM transmission and Bluetooth (BT) are both highly-limited in the number of distinct communication channels that can be simultaneously supported within the same physical environment. Also, such non-scalable wireless solutions usually either limit the number of A/V systems, or the permitted distances between such systems for synchronous operation. These limitations result in a limit on the functionality and/or usability of the A/V systems that can be simultaneously deployed in such an environment.

As an exemplary use-case, given a theatrical screening hall with many viewers, each viewer would like to synchronously listen through headphones to a personalized (e.g., language-specific) version of a soundtrack associated with a centrally-displayed movie. Wired solutions would restrict the viewers' location and mobility, as well as incur high deployment and wiring costs. Wireless solutions such as AM/FM or BT headphones would highly limit the number of distinct audio channels available, and thus the number of viewers that could be simultaneously supported in the same screening hall. Furthermore, limitations on the maximum distance between the A/V output devices would be imposed as well. Implementations using Wi-Fi (or other flexible connectivity solutions) offering unlimited scalability would risk the A/V streams not being synched.

It is noted that any method of providing similar A/V synchronization capabilities could be utilized for enabling the present invention, and the term “A/V synch unit” will be used as a generic, all-encompassing expression for such capabilities in the context of the present invention.

Embodiments of the present invention runner enable: (1) a virtually-unlimited number of synchronized audio channels, thereby allowing more than one movie screening and language editions to be offered via a digital-networking solution in the same screening area; (2) superior audio quality by exploiting the capabilities of the moviegoers' devices; (3) audio access-control capabilities and DRM benefits; and (4) digital signal processing (DSP) capabilities to the audio channels without the need for hardware upgrades to supporting componentry.

Regarding an enhanced, personalized experience, the consumer has the benefit of selecting a personalized, cinema-audio language and type. Thus, different moviegoers can buy tickets to the same screening, sit side by side in the same theater or outdoor screening area, while each moviegoer independently chooses the cinema audio for the screening. For example, different language dubbings or soundtrack types (e.g., “Director's cut”) may be offered on an individual, on-demand basis.

Furthermore, the viewer can independently set a preferred volume level, frequency equalization (e.g., bass boost), and DSP enhancement (e.g., various sound-hall simulations), as well as change such settings during different sections of the screening (e.g., musical transitions versus dialogue portions). The viewer can also independently mute the cinema audio on demand in order to listen to another audio source (e.g., a phone call). The viewer can also benefit from hearing-impaired capabilities (e.g., linking the moviegoer's device to a personal hearing aid). By using a personal audio device, the viewer foregoes the need to rent or otherwise utilize a cinema operator's third-party device, which may suffer from not being ergonomically fit to each viewer's taste, as well as sound quality and multi-user hygiene issues.

Regarding end-to-end DRM and audio distribution, given that the present invention separates playback video and audio channels, synchronously combining the channels only at the endpoint during playback on the viewer's device, media owners and distributors can distribute the audio and video separately. For example, a movie may be distributed to theaters with no audio soundtrack whatsoever, while the audio is delivered during screening from a cloud infrastructure directly to the viewers' devices.

Such implementations enable content owners and distributors to better control and audit actual content consumption. A distributor can obtain the exact number of viewers who watched a given movie screening (e.g., screening location and timeslot) in real time, in contrast to periodic auditing and reliance on reporting by cinema operators. Such real-time management allows for accurate ticket sales/billing as well as a revenue-share model for third-party audio-channel providers, cutting auditing costs dramatically—especially if the management system is located in a remote and central location (e.g., in the “cloud”) as an online service available to any content owner and distributor.

Such implementations further enable localized version provisioning and auditability, resolving the complexities involved in screening dubbed A/V content. As an example of such complexities, since such dubbed audio channels might be fully- or partially-owned by their creators (e.g., a Russian dubbing for a film being typically owned by the Russian distributor) rather than by a film producer, screening a dubbed film outside its region, such as screening a Russian-dubbed movie in Germany, may require the German distributor to acquire the Russian rights beforehand. The costs involved (e.g., cost of the use rights and the costs of a dedicated theater for Russian screenings) versus the risk of satisfactory demand (i.e., enough Russian interest in Germany) would not warrant such a commercial undertaking.

By having a global, centralized infrastructure for delivering cinema-audio channels, such complexity is eliminated. For example, when a Russian dubbing is provisioned in Germany, the cinema-audio system is able to electronically charge the viewer and report usage for revenue-sharing purposes to all involved parties. Moreover, such separation of A/V channel distribution enables enhanced DRM preservation by reducing the likelihood of piracy and online dissemination given that only half of the content in essence is available from any single source (without synchronization), reducing the attraction to such pirated copies.

In addition, differential language pricing is enabled in which each local-version owner can set a desired language-edition price which can be easily managed and controlled globally by a centralized, audio service-provider.

Advanced, audio-based billing models are enabled by the enforcement of audio access control through ticket provisioning. In such a case, a viewer must not only be present at a theater or outdoor screening area in order to listen to the movie soundtrack, but must also purchase a suitable ticket to access a desired audio soundtrack, providing another layer of protection. Particularly, unscrupulous moviegoers trying to watch multiple movies one after the other without purchasing extra tickets (e.g., by lingering in the theater after the end of the first screening).

Enhanced billing and management of outdoor screenings is enabled by creating an additional access barrier for events that traditionally occur in locations which provide some sort of physical access control (e.g., fenced park areas, auditoriums). Similar events taking place in locations that are logistically complicated to provide such physical access control or open-access venues benefit from such enhanced billing and management of audio distribution as means of monetizing such events.

Regarding operational costs and revenue generation for cinema operators, embodiments of the present invention enable viewers to watch the same movie in different languages in the same theater, resulting in higher occupancy rates by eliminating the need to screen a single movie in several theaters (with one for each language), as well as eliminating the need to schedule repeat showings based on forecasted language demand (e.g., screening a movie twice in its native/source language and another time in a foreign dubbing). Both aspects would substantially reduce operating costs for cinema operators. Such multi-language support and the foreign-language provisioning also expands the market to international moviegoers (e.g., immigrants, expatriates, and tourists).

By enabling the screening of multiple movies in the same acoustic space simply by orienting viewers toward different projection screens, embodiments of the present invention enable fewer physical theaters to accommodate a larger number of movies and viewers.

By integrating the BYOD concept, audio-system costs for cinema operators are dramatically reduced. The cost of installing and maintaining a high-quality theatrical audio system is very high. Such a centralized audio system is substituted with the viewers' high-quality personal devices, without negatively impacting the viewer experience.

Regarding superior audio quality, embodiments of the present invention rely on personal devices which: are typically upgraded on a regular basis (in contrast to typical theater sound systems that are usually installed once and rarely upgraded), enable each viewer preferred settings control, provide low-loss digital audio (as opposed to typical RF analog transmission) with enhanced processing options, optimally position each and every viewer by its inherent centralization of the audio with respect to each viewer's ears (i.e., not a “bad” seat in the theater).

It is understood that cinema-audio systems described herein may include their own integrated componentry (i.e., hardware, firmware, and software) for performing their prescribed functions. Thus, componentry such as processors, memory modules, instruction sets, and communication hardware and protocols are implicitly included in the description below of the cinema-audio systems.

Therefore, according to the present invention, there is provided for the first time a method for independent, personalized, video-synchronized, cinema-audio delivery and tracking, the method including the steps of: (a) upon receiving at least one film each having a video source file and at least one audio source file including at least one initial, digital alignment-marker for the video source file and at least one audio source file based on marker information, independently identifying at least one audio-subscriber device; (b) upon receiving at least one request from at least one audio-subscriber device for audio-channel delivery, verifying at least one delivery authorization for at least one audio-subscriber device based on fulfillment criteria; and (c) upon receiving at least one delivery-authorization confirmation, independently delivering and tracking at least one video-synchronized audio channel to each at least one audio-subscriber device.

Alternatively, the method further includes the step of: (d) upon receiving at least one film each having a video source file and at least one audio source file without at least one initial, digital alignment-marker, prior to the step of independently identifying, creating at least one initial, digital alignment-marker for the video source file and at least one audio source file based on marker information.

Alternatively, the method further includes the step of: (d) upon receiving at least one film having a common A/V source file, prior to the step of independently identifying, discretizing the common A/V source file into separate video source file and at least one audio source.

Alternatively, the step of independently identifying is performed using at least one authentication technique selected from the group consisting of: a voucher detail, a ticket number, PIN, a public/private key, a username, a subscriber name, a password, and a phone number.

Alternatively, any subset or all of the steps of independently identifying, verifying, and independently delivering and tracking are performed in a physical location that is remotely located from a film screening of at least one film.

According to the present invention, there is provided for the first time a system for independent, personalized, video-synchronized, cinema-audio delivery and tracking, the system including: (a) a CPU for performing computational operations; (b) a memory module for storing data; (c) a network connection for communicating across a data-exchange protocol system; and (d) an audio-managing module configured for: (i) upon receiving at least one film each having a video source file and at least one audio source file including at least one initial, digital alignment-marker for the video source file and at least one audio source file based on marker information, independently identifying at least one audio-subscriber device; (ii) upon receiving at least one request from at least one audio-subscriber device for audio-channel delivery, verifying at least one delivery authorization for at least one audio-subscriber device based on fulfillment criteria; and (iii) upon receiving at least one delivery-authorization confirmation, independently delivering and tracking at least one video-synchronized audio channel to each at least one audio-subscriber device.

Alternatively, the audio-managing module is further configured for: (iv) upon receiving at least one film each having a video source file and at least one audio source file without at least one initial, digital alignment-marker, prior to the independently identifying, creating at least one initial, digital alignment-marker for the video source file and at least one audio source file based on marker information.

Alternatively, the audio-managing module is further configured for: (iv) upon receiving at least one film having a common A/V source file, prior to the independently identifying, discretizing the common A/V source file into separate video source file and at least one audio source.

Alternatively, the independently identifying is performed using at least one authentication technique selected from the group consisting of: a voucher detail, a ticket number, PIN, a public/private key, a username, a subscriber name, a password, and a phone number.

Alternatively, the audio-managing module is configured to perform any subset or all of the creating, independently identifying, verifying, and independently delivering and tracking in a physical location that is remotely located from a film screening of at least one film.

According to the present invention, there is provided for the first time a non-transitory computer-readable storage medium, having computer-readable code embodied on the non-transitory computer-readable storage medium, for independent, personalized, video-synchronized, cinema-audio delivery and tracking, the computer-readable code including: (a) program code for, upon receiving at least one film each having a video source file and at least one audio source file including at least one initial, digital alignment-marker for the video source file and at least one audio source file based on marker information, independently identifying at least one audio-subscriber device; (b) program code for, upon receiving at least one request from at least one audio-subscriber device for audio-channel delivery, verifying at least one delivery authorization for at least one audio-subscriber device based on fulfillment criteria; and (c) program code for, upon receiving at least one delivery-authorization confirmation, independently delivering and tracking at least one video-synchronized audio channel to each at least one audio-subscriber device.

Alternatively, the computer-readable code further includes: (d) program code for, upon receiving at least one film each having a video source file and at least one audio source file without at least one initial, digital alignment-marker, prior to the independently identifying, creating at least one initial, digital alignment-marker for the video source file and at least one audio source file based on marker information.

Alternatively, the computer-readable code further includes: (d) program code for, upon receiving at least one film having a common A/V source file, prior to the independently identifying, discretizing the common A/V source file into separate video source file and at least one audio source.

Alternatively, the independently identifying is performed using at least one authentication technique selected from the group consisting of: a voucher detail, a ticket number, PIN, a public/private key, a username, a subscriber name, a password, and a phone number.

Alternatively, the program code is configured to perform any subset or all of the creating, independently identifying, verifying, and independently delivering and tracking in a physical location that is remotely located from a film screening of at least one film.

These and further embodiments will be apparent from the detailed description that follows.

### BRIEF DESCRIPTION OF THE DRAWINGS

The present invention is herein described, by way of example only, with reference to the accompanying drawings, wherein:

FIG. 1 is a simplified high-level schematic diagram of a typical system implementation for independent, personalized, video-synchronized, cinema-audio delivery and tracking, according to embodiments of the present invention;

FIG. 2 is a simplified high-level schematic diagram of a typical system architecture for independent, personalized, video-synchronized, cinema-audio delivery and tracking, according to embodiments of the present invention;

FIG. 3 is a simplified flowchart of the major process steps of an independent, personalized, video-synchronized, cinema-audio delivery and tracking system, according to embodiments of the present invention.

### DESCRIPTION OF THE ILLUSTRATIVE EMBODIMENTS

The present invention relates to methods and systems for independent, personalized, video-synchronized, cinema-audio delivery and tracking. The principles and operation for providing such methods and systems, according to the present invention, may be better understood with reference to the accompanying description and the drawings.

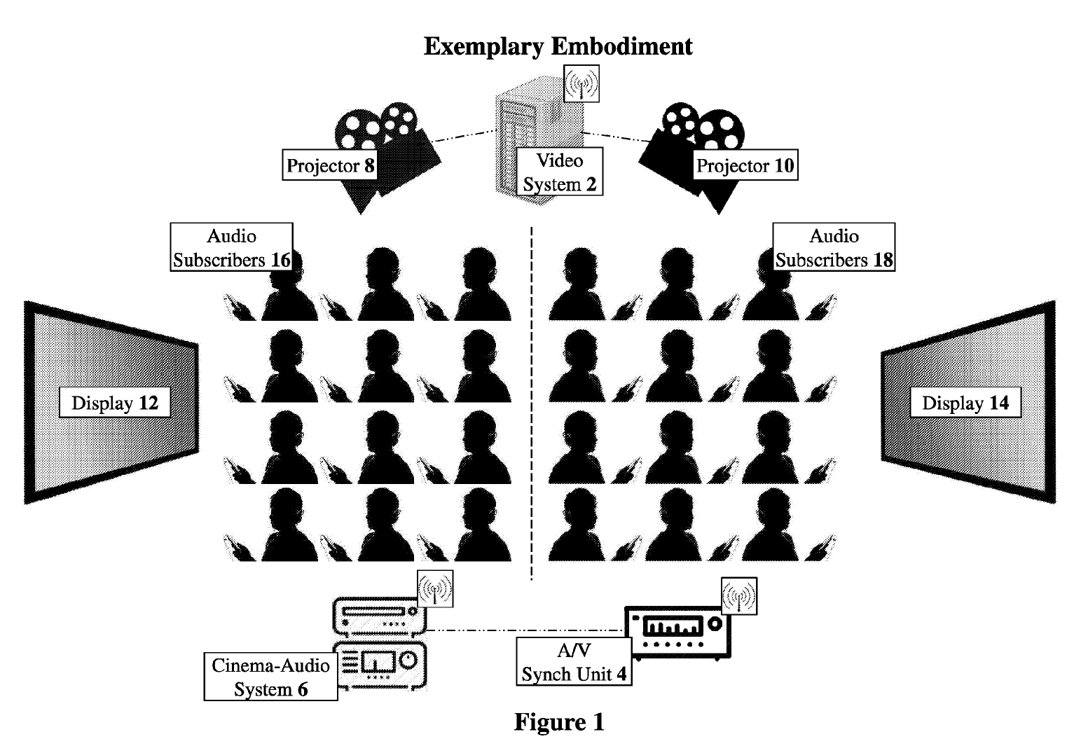

Referring to the drawings, FIG. 1 is a simplified high-level schematic diagram of a typical system implementation for independent, personalized, video-synchronized, cinema-audio delivery and tracking, according to embodiments of the present invention. The exemplary embodiment depicted includes a video system 2, an A/V synch unit 4, and a cinema-audio system 6. Video system 2 is shown operationally connected to video projectors 8 and 10, which present video content on displays 12 and 14 (e.g., TV monitors, video monitors, and cinema screens), respectively. Audio subscribers 16 and 18 are shown (with audio-subscriber devices, not labeled) facing displays 12 and 14, respectively. Alternate arrangements and implementations of video system 2, A/V synch unit 4, video projectors 8 and 10, displays 12 and 14, and any ancillary, supporting, system componentry, as well as integration of such elements in multifunction systems (or locating such systems or sub-systems remotely), is fully contemplated within the context of the present invention, and is represented in FIG. 1 in a non-limiting manner.

A/V synch unit 4 may operate over any flexible (i.e., having high-latency and/or low-bandwidth) networking platform available, wired or wireless, including high-level computer-based networks (e.g., Wi-Fi, Ethernet, cellular 3G/4G, and the Internet), which usually cannot necessarily guarantee low-enough latency and high-enough bandwidth.

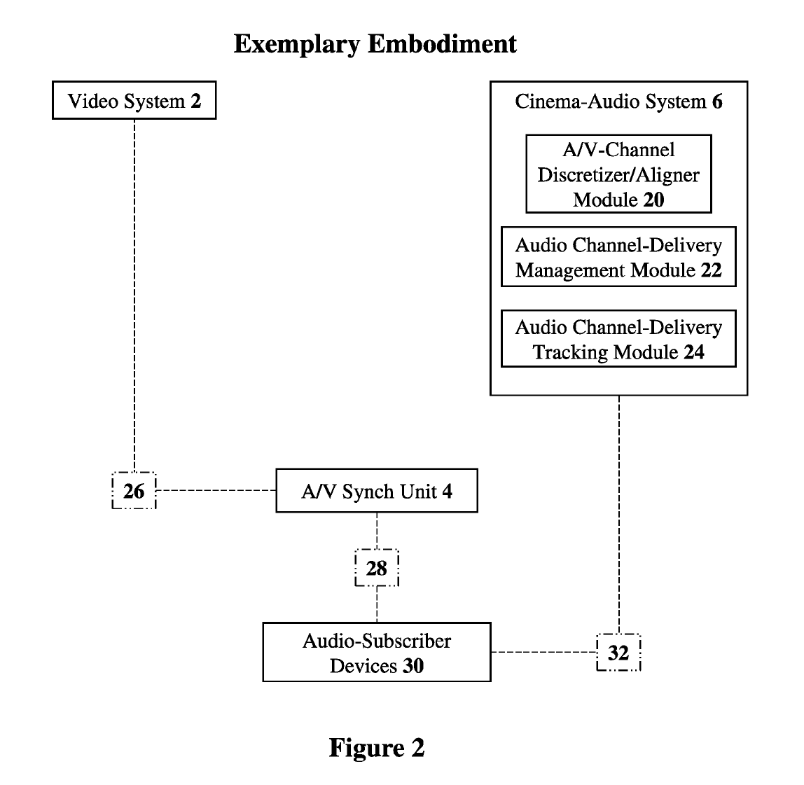

FIG. 2 is a simplified high-level schematic diagram of a typical system architecture for independent, personalized, video-synchronized, cinema-audio delivery and tracking, according to embodiments of the present invention. The exemplary embodiment depicts video system 2, A/V synch unit 4, and cinema-audio system 6 in an operational configuration.

Cinema-audio system 6 includes an A/V-channel discretizer/aligner module 20, an audio channel-delivery management module 22, and an audio channel-delivery tracking module 24.

Video system 2 operationally connects to A/V synch unit 4 via a communication channel 26 (e.g., hard wiring, Wi-Fi, BT, Ethernet, cellular 3G/4G, LTE, or any other supported protocol), respectively. A/V synch unit 4 “orchestrates” the performance event by synchronizing system clocks, and informing audio subscribers (not shown in FIG. 2) what audio segment to play at any given time, which is governed by the current video segment playing accounting for any network lags. A/V synch unit 4 manages such synchronization by operationally connecting to audio-subscriber devices 30 (e.g., smartphones or dedicated personal audio devices) via a communication channel 28.

All audio subscribers receive their audio portion of the performance event on audio-subscriber devices 30 for playback via peripheral output devices (e.g., speakers, headphones, and BT headphones), not shown in FIG. 2. Audio-subscriber devices 30 operationally connect to cinema-audio system 6 via a communication channel 32.

A/V-channel discretizer/aligner module 20 preprocesses the A/V source files by aligning any relevant audio file with a separate video file. Such preprocessing may be performed in several ways. For example, by creating an initial, digital alignment-marker at the beginning of the source files that need to be synchronized. Another alignment method could be to ensure both the audio and video file start simultaneously for instances in which the files opening frame/segment are preconfigured to be synchronized. This can be performed by video system 2 sending marker information to A/V synch unit 4. Such an alignment-marker can be designated in any segment of the source files prior to the start of the synchronized content. Subsequent synchronization of the source files during play-display screening, as well as adding latecomers to the screening, is handled by A/V synch unit 4. In some embodiments, it is noted that the preprocessing of A/V-channel discretizer/aligner module 20 can be performed by a third party prior to cinema-audio system 6 receiving the A/V source files.

Optionally, A/V-channel discretizer/aligner module 20 can also extract the audio portion from a common A/V source file. Such A/V-channel discretization creates the initial, digital alignment-marker at the same time as the audio channel is extracted from the original A/V file. Channel discretizer/aligner module 20 may operate during the A/V screening (i.e., “on the fly”), or alternatively offline (i.e., before the screening) in which the audio channel is preprocessed in advance.

Audio channel-delivery management module 22 manages the access rights to the audio, and ensures that every subscriber is allowed to access only the audio content that access has been granted to (e.g., only for the movie for which a ticket was purchased, and only for the language requested and authorized). As such, audio channel-delivery management module 22 authenticates the identity of audio subscriber via their audio-subscriber devices 30 using any valid authentication method (e.g., voucher detail, ticket number, PIN, public/private key, username/password, and/or phone number) that will link the subscriber to a set of audio resources to which access has been permitted. Audio channel-delivery tracking module 24 tracks the subscribers' audio activity, and maintains channel-delivery records for billing, marketing and auditing purposes.

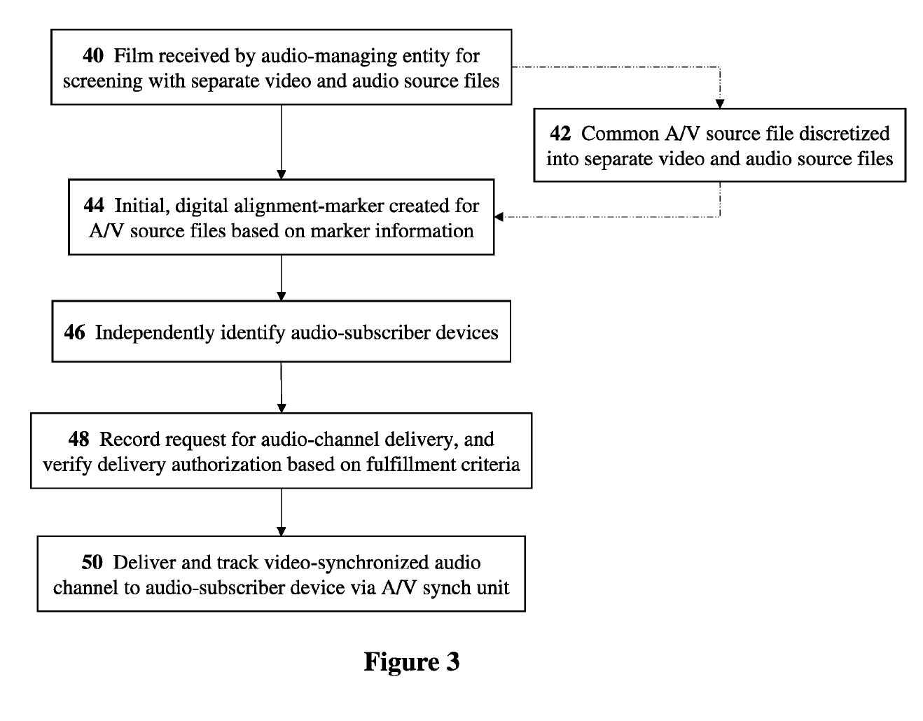

FIG. 3 is a simplified flowchart of the major process steps of an independent, personalized, video-synchronized, cinema-audio delivery and tracking system, according to embodiments of the present invention. The process starts when a film to be screened is received by an “audio-managing entity” (Step 40). In general, the film includes a video source file and at least one audio file which can be separate files, or bundled together with the video source file. The video source file is loaded into the video system, while the audio files are loaded into the cinema-audio system.

Optionally, in the event that the film's A/V channels are contained in one common A/V source file, the cinema-audio system extracts the audio portions into separate source files (Step 42). The cinema-audio system (or a third party) then preprocesses the film by creating an initial, digital alignment-marker for the video and audio source files based on marker information obtained from the A/V synch unit (Step 44). Step 44 can be performed either as a “back-office” operation (e.g., when a film distributor decides to distribute the film to the cinemas), or as an “on-site” operation (e.g., when a film is sent to a cinema operator for screening).

The cinema-audio system then independently identifies audio-subscriber devices (Step 46). Upon receiving a request for an audio-channel delivery to an audio-subscriber device, the cinema-audio system records the request, and verifies delivery authorization based on various fulfillment criteria (e.g., device identification and payment confirmation) (Step 48). Upon delivery-authorization confirmation, the cinema-audio system delivers and tracks the video-synchronized audio channel to the audio-subscriber device (Step 50).

The digital network allows audio subscribers to connect to the cinema operator's electronic ticket booth for online ticket purchase, or to confirm the audio-subscriber device at a physical ticket booth with a sales agent. During the film screening, audio subscribers can listen to the purchased synchronized soundtrack through their personal devices, as well as adjust various settings, equalization, and other aural enhancements throughout the screening. Various ticket options can allow enhanced quality or customization settings.

While the present invention has been described with respect to a limited number of embodiments, it will be appreciated that many variations, modifications, and other applications of the present invention may be made.

What is claimed is:

1. A method for independent, personalized, video-synchronized, cinema-audio delivery and tracking, the method comprising the steps of:
(a) upon receiving at least one film each having a video source file and at least one audio source file including at least one initial, digital alignment-marker for said video source file and said at least one audio source file based on marker information, independently identifying at least one audio-subscriber device;
(b) upon receiving at least one request from said at least one audio-subscriber device for audio-channel delivery, verifying at least one delivery authorization for said at least one audio-subscriber device based on fulfillment criteria; and
(c) upon receiving at least one delivery-authorization confirmation, independently delivering and tracking at least one video-synchronized audio channel to each said at least one audio-subscriber device.

2. The method of claim 1, the method further comprising the step of:
(d) upon receiving at least one film each having a video source file and at least one audio source file without said at least one initial, digital alignment-marker, prior to said step of independently identifying, creating said at least one initial, digital alignment-marker for said video source file and said at least one audio source file based on marker information.

3. The method of claim 1, the method further comprising the step of:
(d) upon receiving at least one film having a common A/V source file, prior to said step of independently identifying, discretizing said common A/V source file into separate said video source file and said at least one audio source.

4. The method of claim 1, wherein said step of independently identifying is performed using at least one authentication technique selected from the group consisting of: a voucher detail, a ticket number, PIN, a public/private key, a username, a subscriber name, a password, and a phone number.

5. The method of claim 1, wherein any subset or all of said steps of independently identifying, verifying, and independently delivering and tracking are performed in a physical location that is remotely located from a film screening of said at least one film.

6. A system for independent, personalized, video-synchronized, cinema-audio delivery and tracking, the system comprising:
(a) a CPU for performing computational operations;
(b) a memory module for storing data;
(c) a network connection for communicating across a data-exchange protocol system; and
(d) an audio-managing module configured for:
(i) upon receiving at least one film each having a video source file and at least one audio source file including at least one initial, digital alignment-marker for said video source file and said at least one audio source file based on marker information, independently identifying at least one audio-subscriber device;
(ii) upon receiving at least one request from said at least one audio-subscriber device for audio-channel delivery, verifying at least one delivery authorization for said at least one audio-subscriber device based on fulfillment criteria; and
(iii) upon receiving at least one delivery-authorization confirmation, independently delivering and tracking at least one video-synchronized audio channel to each said at least one audio-subscriber device.

7. The system of claim 6, wherein said audio-managing module is further configured for:
(iv) upon receiving at least one film each having a video source file and at least one audio source file without said at least one initial, digital alignment-marker, prior to said independently identifying, creating said at least one initial, digital alignment-marker for said video source file and said at least one audio source file based on marker information.

8. The system of claim 6, wherein said audio-managing module is further configured for:
(iv) upon receiving at least one film having a common A/V source file, prior to said independently identifying, discretizing said common A/V source file into separate said video source file and said at least one audio source.

9. The system of claim 6, wherein said independently identifying is performed using at least one authentication technique selected from the group consisting of: a voucher detail, a ticket number, PIN, a public/private key, a username, a subscriber name, a password, and a phone number.

10. The system of claim 6, wherein said audio-managing module is configured to perform any subset or all of said independently identifying, verifying, and independently delivering and tracking in a physical location that is remotely located from a film screening of said at least one film.

11. A non-transitory computer-readable storage medium, having computer-readable code embodied on the non-transitory computer-readable storage medium, for independent, personalized, video-synchronized, cinema-audio delivery and tracking, the computer-readable code comprising:
(a) program code for, upon receiving at least one film each having a video source file and at least one audio source file including at least one initial, digital alignment-marker for said video source file and said at least one audio source file based on marker information, independently identifying at least one audio-subscriber device;
(b) program code for, upon receiving at least one request from said at least one audio-subscriber device for audio-channel delivery, verifying at least one delivery authorization for said at least one audio-subscriber device based on fulfillment criteria; and
(c) program code for, upon receiving at least one delivery-authorization confirmation, independently delivering and tracking at least one video-synchronized audio channel to each said at least one audio-subscriber device.

12. The non-transitory computer-readable storage medium of claim 11, the computer-readable code further comprising:
(d) program code for, upon receiving at least one film each having a video source file and at least one audio source file without said at least one initial, digital alignment-marker, prior to said independently identifying, creating said at least one initial, digital alignment-marker for said video source file and said at least one audio source file based on marker information.

13. The non-transitory computer-readable storage medium of claim 11, the computer-readable code further comprising:
(d) program code for, upon receiving at least one film having a common A/V source file, prior to said independently identifying, discretizing said common A/V source file into separate said video source file and said at least one audio source.

14. The non-transitory computer-readable storage medium of claim 11, wherein said independently identifying is performed using at least one authentication technique selected from the group consisting of: a voucher detail, a ticket number, PIN, a public/private key, a username, a subscriber name, a password, and a phone number.

15. The non-transitory computer-readable storage medium of claim 11, wherein said program code is configured to perform any subset or all of said independently identifying, verifying, and independently delivering and tracking in a physical location that is remotely located from a film screening of said at least one film.
